(19) United States
(12) Patent Application Publication
(10) Pub. No.: US 2016/0148200 A1
(43) Pub. Date: May 26, 2016

(54) METHODS, SYSTEMS, AND DEVICES FOR TRANSFORMING INFORMATION PROVIDED BY COMPUTING DEVICES

(71) Applicants: Taweechai PUREETIP, Huaykwang Bangkok (TH); Natwut AMORNVIVAT, Jatuchak Bangkok (TH); Charatpong CHOTIGAVANICH, Suanluang Bangkok (TH)

(72) Inventors: Taweechai PUREETIP, Bangkok (TH); Natwut AMORNVIVAT, Bangkok (TH); Charatpong CHOTIGAVANICH, Bangkok (TH)

(21) Appl. No.: 14/907,258

(22) PCT Filed: Feb. 28, 2014
(86) PCT No.: PCT/TH2014/000007

§ 371 Date: Jan. 22, 2016

(51) Int. Cl. G06Q 20/38; G06Q 20/10; G06Q 20/06

(52) U.S. Cl. CPC G06Q 20/381; G06Q 20/0658; G06Q 20/10

(57) ABSTRACT

Example embodiments relate generally to methods, systems, and devices for transforming information. The system may comprise a network and processor. The processor may be operable to establish a first communication channel with a first device, establish a second communication channel with a second device, create a first account based on information received from the first device, create a second account based on information received from the second device, associate a first computer-enabled account to the first account and a second computer-enabled account to the second account, create a computer-processable indicia associated with the first account, create a network link between the first account and the second account, perform a transformation of information received from the first device by receiving, from the first device, a computer-processable request including the computer-processable indicia associated with the first account, and processing the computer-processable request.

### BACKGROUND

The present disclosure relates generally to methods, systems, and devices for transforming information provided by computing devices.

In today's constantly evolving information technology world, users are spending increasing amounts of time using computing devices. Examples of computing devices include traditionally non-portable devices, such as desktop computers, televisions, media players, internet kiosks, smart appliances, and the like, and portable devices, such as laptops, tablets, mobile phones, digital cameras, video recorders, media players, readers, wearable computing devices such as the Samsung Galaxy Gear and the Google Glasses, and the like.

Telecommunication providers are contributing to increased user usage and improved user experience by offering, among other things, lower cost internet services, higher speed internet access, broader geographic coverage for internet access, and more value-added services. With said improved access to information and affordability, businesses, such as those who offer products and/or services to users, or the like, are becoming increasingly empowered to entice and/or attract users to their offerings, such as products and/or services, by offering more interesting information, content, and the like. Examples include information via e-mail, SMS, chats, instant messaging, and etc.

Despite improvements to information access and ways to convey more interesting content, products, and services, users and providers alike oftentimes encounter problems with transforming information received and/or provided, via a network, by computing devices.

### BRIEF SUMMARY

Present example embodiments relate generally to methods, systems, devices, and computer readable medium for transforming information provided by computing devices.

In an example embodiment, a system for transforming information provided by computing devices into computer-implementable instructions is provided. The system may comprise a network and a processor in communication with the network. The processor may be operable to establish a first communication channel with a first user device via the network. The processor may also be operable to establish a second communication channel with a second user device via the network. The processor may also be operable to create a first user account based on information received from the first user device via the first communication channel. The processor may also be operable to create a second user account based on information received from the second user device via the second communication channel. The processor may also be operable to associate a first computer-enabled account to the first user account and a second computer-enabled account to the second user account. The processor may also be operable to create a computer-processable indicia associated with the first user account, the computer-processable indicia for use in transforming information receivable by the processor into instructions implementable by the processor. The processor may also be operable to create a network link between the first user account and the second user account. The processor may also be operable to perform a transformation of information received from the first user device by receiving, from the first user device, a computer-processable request, the computer-processable request including the computer-processable indicia associated with the first user account. The processor may also be operable to perform the transformation of information received from the first user device by processing the computer-processable request, the processing of the computer-processable request based on a current status of the first user account and the network link between the first user account and the second user account.

### BRIEF DESCRIPTION OF THE DRAWINGS

For a more complete understanding of the present disclosure, example embodiments, and their advantages, reference is now made to the following description taken in conjunction with the accompanying drawings, in which like reference numbers indicate like features, and:

FIG. 1 is an example illustration of an example embodiment of a network;

FIG. 2 is an example illustration of an example embodiment of a network system;

FIG. 3 is an example illustration of an example embodiment of a method of performing a transaction;

FIG. 4 is an example illustration of an example embodiment of a method of processing a transaction request; and

FIG. 5 is an example illustration of an example embodiment of a method of completing a transaction request.

Although similar reference numbers may be used to refer to similar elements for convenience, it can be appreciated that each of the various example embodiments may be considered to be distinct variations.

Example embodiments will now be described with reference to the accompanying drawings, which form a part of the present disclosure, and which illustrate example embodiments which may be practiced. As used in the present disclosure and the appended claims, the terms “example embodiment,” “exemplary embodiment,” and “present embodiment” do not necessarily refer to a single embodiment, although they may, and various example embodiments may be readily combined and/or interchanged without departing from the scope or spirit of example embodiments. Furthermore, the terminology as used in the present disclosure and the appended claims is for the purpose of describing example embodiments only and is not intended to be limitations. In this respect, as used in the present disclosure and the appended claims, the term “in” may include “in” and “on,” and the terms “a,” “an” and “the” may include singular and plural references. Furthermore, as used in the present disclosure and the appended claims, the term “by” may also mean “from,” depending on the context. Furthermore, as used in the present disclosure and the appended claims, the term “if” may also mean “when” or “upon,” depending on the context. Furthermore, as used in the present disclosure and the appended claims, the words “and/or” may refer to and encompass any and all possible combinations of one or more of the associated listed items.

### DETAILED DESCRIPTION

The present disclosure relates generally to methods, systems, and devices for implementing a social network, and more particularly, methods, systems, and devices for performing a transaction, including borrowing funds and returning borrowed funds, via a social network.

In today's constantly evolving information technology world, consumers are spending increasing amounts of time using computing devices. Examples of computing devices include traditionally non-portable devices, such as desktop computers, televisions, media players, internet kiosks, point of sale (POS) terminals, smart appliances, and the like, and portable devices, such as laptops, tablets, mobile phones, digital cameras, video recorders, media players, readers, wearable computing devices such as the Samsung Galaxy Gear and the Google Glasses, and the like.

Telecommunication providers are contributing to increased consumer usage and improved consumer experience by offering, among other things, lower cost internet services, higher speed internet access, broader geographic coverage for internet access, and more value-added services. With said improved access to information and affordability, businesses, such as those who offer products and/or services to consumers, or the like, are becoming increasingly empowered to entice and/or attract consumers to purchase their offerings, such as products and/or services, by offering more interesting online advertisements, coupons, specials, content, and the like. Examples include advertisements for new product and/or service offerings, discounts, and/or specials via e-mail, SMS, chats, instant messaging, and social network-based media such as Twitter (Tweets) and Facebook.

Despite improvements to information access and ways to convey more interesting content, products, and services, consumers oftentimes find themselves financially restricted from purchasing products and/or services. For example, a consumer may physically visit a retail store and/or visit an online shop and see one or more products and/or services of interest, but the consumer may not have available funds in the possession of the consumer and/or available to the consumer (such as in the consumer's bank account, credit account, rewards points account, or the like) to complete the purchase.

For example, oftentimes a consumer may physically visit a store and/or an online store and become interested in one or more purchasable items. As used herein, the terms “purchasable item,” “content,” “product,” and/or “service” may refer to any product, service, software, content, membership or subscription fee, downloadable file, information, debt repayment, investment, charitable donation, and the like, available to a person to have, receive, access, and/or perform, as the case may be, in exchange for money, reward points, or the like, via any method, such as by performing a transaction at a physical store and/or via online methods. The consumer may wish to perform a transaction for the purchasable item, but realize that he/she is unable to complete the transaction due to, among other things, personal financial restrictions such as insufficient funds (such as cash, credit, reward points, or the like) in the possession of the consumer or insufficient funds available in the consumer's bank account (such as a savings, checking, or investment account), credit account (such as a credit card account provided by banks or credit card companies such as Visa, MasterCard, American Express, Diners Club, or the like), rewards point account (such as those offered by retailers, airlines, hotels, restaurants, credit card companies, and the like), or the like.

The consumer may attempt to borrow the required funds, which may be the total amount of the transaction (including applicable taxes, service charges, delivery charges, etc.) or the difference between the total amount of the transaction and the funds available to the consumer, from friends. However, doing so typically introduces one or more problems. For example, the consumer may be uncomfortable, embarrassed, or may have certain other undesirable emotions towards asking a friend to borrow money. As another example, the consumer may not be within a close proximity of a friend who can lend the consumer the money. In this regard, the consumer may be required to contact the friend, such as by making a telephone call, sending an email, sending an instant message, or the like, ask the friend to borrow the required funds, and then meet with the friend or have the friend send over money to obtain the required funds to complete the transaction.

Present example embodiments relate generally to methods, systems, devices, and computer readable medium for solving one or more of the problems encountered by consumers today, including those described above and in the present disclosure. In particular, example embodiments described in the present disclosure relate to methods, devices, systems, and computer readable medium for use in implementing a social network and enabling registered users having a registered user account in the social network to quickly, easily, and at any time and place complete a transaction, such as a transaction for a purchasable item, when the registered user has sufficient and available funds to complete the transaction and/or when the registered user has insufficient and/or unavailable funds to complete the transaction.

In an example embodiment, a method of performing a transaction between a user device and a third party is described. The method comprises providing, from the user device, an indicia associated with a first user account. The first user account is one of a plurality of user accounts of a social network. The method further comprises transmitting, to one or more social network servers, a transaction request including a total amount of the transaction and the indicia. The method further comprises processing, by the one or more social network servers, the transaction request. The method further comprises completing, by the one or more social network servers, the transaction request by causing a transfer of the total amount of the transaction to a fund account associated with the third party. At least a first portion of the transferred total amount of the transaction is provided from a fund account associated with a second user account registered in the social network.

In another example embodiment, a system is described for use in processing a transaction. The system comprises one or more social network servers, a user device, and a database associated with one or more social network servers. The one or more social network servers are operable to implement a social network having a plurality of user accounts. Each user account comprises social links to one or more other user accounts. The one or more social network servers operable to receive a transaction request including an indicia associated with a first user account of the plurality of user accounts of the social network and a total amount of the transaction. The one or more social network servers are also operable to identify the first user account via the indicia. The one or more social network servers are also operable to identify one or more user accounts socially linked to the first user account as candidates. The one or more social network servers are also operable to select a second user account from among the identified candidates based on a criteria set by one or more of the first user account and the second user account. The one or more social network servers are also operable to complete the transaction request by causing a transfer of the total amount of the transaction to a fund account associated with a third party. At least a first portion of the transferred total amount of the transaction is provided from a fund account associated with the second user account. The user device is operable to provide the indicia. The database is operable to store the plurality of user accounts of the social network, the social links between the first user account and the candidates, the indicia associated with the first user account, and the fund account associated with the second user account.

In another example embodiment, a method of implementing a social network is described comprising creating a first user account and a second user account. The method further comprises associating a first fund account to the first user account and a second fund account to the second user account. The method further comprises creating an indicia associated with the first user account, the indicia for use in performing a transaction. The method further comprises creating a social link between the first user account and the second user account. The method further comprises receiving a transaction request, the transaction request including a total amount of the transaction and the indicia associated with the first user account. The method further comprises processing the transaction request by causing a transfer of the total amount of the transaction. At least one portion of the transferred total amount of the transaction is provided from the second fund account associated with the second user account.

In another example embodiment, a method of completing a transaction between a purchaser and a seller is described comprising identifying, by a device of the seller, an indicia associated with a first user account of the purchaser, wherein the first user account is socially linked with one or more other user accounts in a social network. The method further comprises transmitting, by the seller device, a transaction request including the identified indicia and a total amount of the transaction. The method further comprises receiving, by one or more social network servers, the transaction request. The method further comprises comparing, by the one or more social network servers, the total amount of the transaction with a first amount in a fund account associated with the first user account. When the first amount is greater than or equal to the total amount of the transaction, the method further comprises completing the transaction by causing the total amount of the transaction to be sent to a fund account associated with the seller from the fund account associated with the first user account. When the first amount is less than the total amount of the transaction, the method further comprises completing the transaction by determining a difference between the total amount of the transaction and the first amount; obtaining at least a first portion of the difference between the total amount of the transaction and the first amount from a fund account associated with a second user account socially linked to the first user account in the social network; and causing the total amount of the transaction to be sent to the seller system from at least the first amount and the obtained first portion.

In another example embodiment, a social network server is described for implementing a social network having a plurality of user accounts. Each user account comprises social links to one or more other user accounts. The social network server comprises a processor and a database. The processor is operable to receive a transaction request including an indicia associated with a first user account of the plurality of user accounts of the social network and a total amount of the transaction. The processor is also operable to identify the first user account via the indicia. The processor is also operable to identify one or more user accounts socially linked to the first user account as candidates. The processor is also operable to select a second user account from among the identified candidates based on a criteria set by one or more of the first user account and the second user account. The processor is also operable to complete the transaction request by causing a transfer of the total amount of the transaction to a fund account associated with a third party. At least a first portion of the transferred total amount of the transaction is provided from a fund account associated with the second user account. The database is in communication with the processor. The database is operable to store the plurality of user accounts of the social network, the social links between the first user account and the candidates, the indicia associated with the first user account, and the fund account associated with the second user account.

These and other example embodiments will now be described and with reference to the accompanying figures.

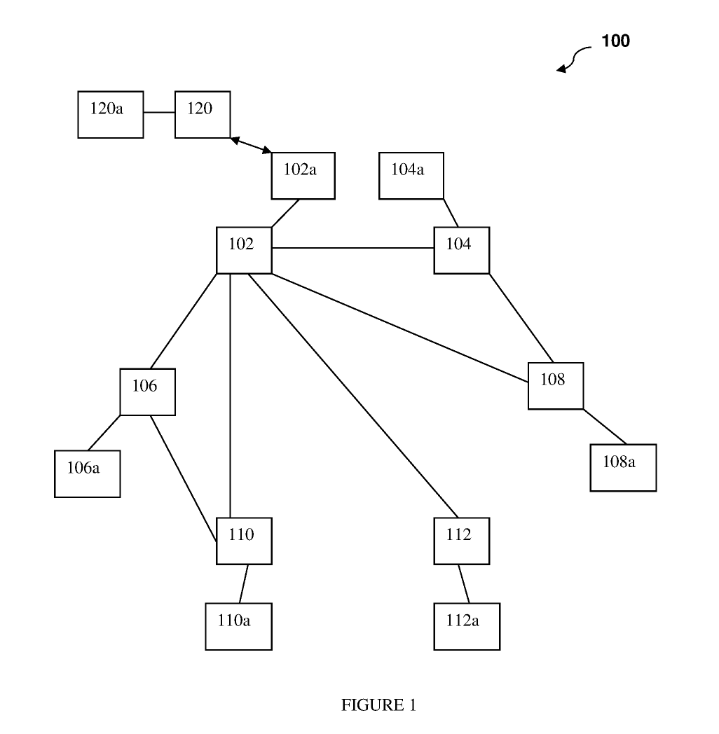

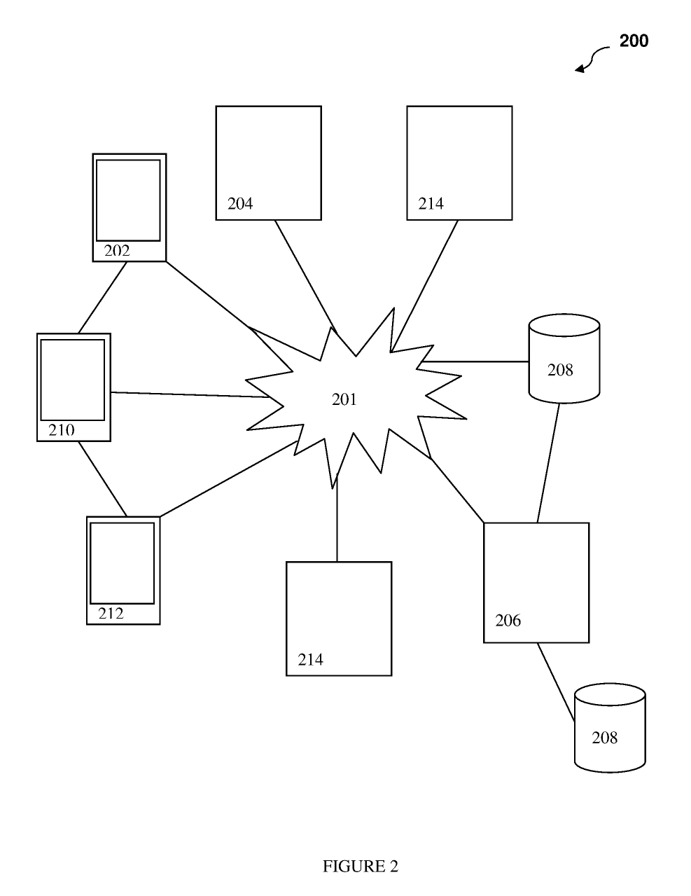

FIG. 1 illustrates a social network 100 according to an example embodiment of the present disclosure. The social network 100 may comprise a plurality of registered user accounts of the social network 100, such as user accounts 102, 104, 106, 108, 110, and 112 depicted in FIG. 1. Each user account 102, 104, 106, 108, 110, and 112 may also comprise an indicia, such as a unique series of characters, user account number, or the like, associated with the user account. One or more of the user accounts 102, 104, 106, 108, 110, and 112 may have one or more fund accounts 102a, 104a, 106a, 108a, 110a, and 112a associated with the user account and/or the indicia. For example, a first user account 102 may have a fund account 102a associated with the first user account 102 and/or the indicia of the first user account 102; a second user account 104 may have a fund account 104a associated with the second user account 104 and/or the indicia of the second user account 104; a third user account 106 may have a fund account 106a associated with the third user account 106 and/or the indicia of the third user account 106; a fourth user account 108 may have a fund account 108a associated with the fourth user account 108 and/or the indicia of the fourth user account 108; a fifth user account 110 may have a fund account 110a associated with the fifth user account 110 and/or the indicia of the fifth user account 110; and a sixth user account 112 may have a fund account 112a associated with the sixth user account 112 and/or the indicia of the sixth user account 112. Each fund account may be said to be associated with each user account and/or the indicia of the user account when one or more social network servers (or processors) (such as 206 illustrated in FIG. 2) and/or one or more user accounts in the social network 100 is/are allowed and/or authorized to, either directly or indirectly, access funds and/or cause access to funds of the fund account pursuant to settings (indicated by the owner or user of the user account and/or pursuant to default settings, as the case may be), instructions from one or more of the social network servers 206, instructions from the owner (or user or administrator) of the user account, instructions from one or more parties transacting with the owner (or user or administrator) of the user account, and/or the like. As used in the present disclosure, references to “accessing funds,” “access funds,” “access to funds,” and the like, of a fund account will refer to transactions by using or obtaining funds in the fund account, and such transactions may include deposits, withdrawals, payments, transacting for purchasable items, and/or transfers.

A seller 120, who may or may not have a registered account or be a registered user of the social network 100, may also have a fund account 120a associated with the seller 120, and such association may or may not be in the same manner as the fund accounts associated with the user accounts in the social network 100 described above and herein. It is to be understood in the present disclosure that a fund account associated with a user account in the social network 100 (and/or the seller 120) may be any one or more of an electronic wallet or cash top-up account, such as an electronic wallet managed and/or operated by the social network 100 and/or third party, and refillable in any one of a plurality of ways, including transfers from a bank account, transfers at a POS system of a retail store such as 7 Eleven, Family Mart, etc., transfers from an ATM machine, and the like; bank account, such as a savings account, a checking account, an investment account, and the like; a PayPal account; any other type of cash-based account; a credit card account, such as a Visa, a MasterCard, American Express, Diners Club, and the like; any other type of credit-based account, such as a retailer credit account; a cash advance account; a reward point account, such as those offered by retailers, airlines, hotels, restaurants, credit card companies, and the like; a multi-purpose account, such as an Octopus card, a Rabbit card, and the like; and the like.

As illustrated by the lines drawn between the user accounts 102, 104, 106, 108, 110, and 112 in FIG. 1, each of the user accounts may have one or more links, including a social link, to one or more other user accounts in the social network 100. Each social link, which may be a persistent link, a temporary link, an M-occurrence use link (wherein M represents an integer greater than or equal to 1), or an N-duration use link (where N represents a duration of time, such as minutes, hours, days, weeks, months, years, etc.), may be established when a user account, such as first user account 102, sends a link request to link in a social and/or transactional manner to another user account, such as second user account 104, and the another user account (in this case, the second user account 104) accepts the link request. As will be further explained below, the accepting of a link request may also include, among other things, an authorization from the another user account 104 to allow the requester(s) (in this case, the first user account 102) to access funds, either automatically or with prior approval from the another user account 104, from the fund account 104a of the another user account 104. In example embodiments, the accepting of a link request may also include a mutual authorization from both the requester 102 and the another user account 104 to allow each other to access funds, either automatically or with prior approval from the other, from the fund account of the other.

As illustrated in the example of FIG. 1, the first user account 102 may be socially linked to the second user account 104, the third user account 106, the fourth user account 108, the fifth user account 110, and the sixth user account 112. The second user account 104 may be socially linked to the first user account 102 and the fourth user account 108. The third user account 106 may be socially linked to the first user account 102 and the fifth user account 110. The fourth user account 108 may be socially linked to the first user account 102 and the second user account 104. The fifth user account 110 may be socially linked to the first user account 102 and the third user account 106. The sixth user account 112 may be socially linked to the first user account 102. It is to be understood in the present disclosure that the user accounts 102, 104, 106, 108, 110, and 112 and the social links between user accounts depicted in FIG. 1 are merely example representations of user accounts and social links in the social network 100, and that example embodiments of the social network 100 may comprise many orders of magnitude more user accounts and social links between user accounts without departing from the teachings of the present disclosure.

The social network 100 may be implementable in one of a plurality of ways, including those known in the art, such as those implemented by Facebook, Google, Apple, Yahoo, AOL, Microsoft, MySpace, WhatsApp, Yelp, Baidu, and the like. In an example embodiment, such as that depicted in FIG. 2, a social network system 200 for use in implementing the social network 100 may comprise one or more social network servers (and/or processors) 206 and one or more databases 208 associated with the one or more social network servers 206. The social network system 200 may further comprise one or more user devices 202, 210, and 212. The social network system 200 may further comprise one or more seller machines 204. The social network system 200 may further comprise one or more financial institution systems 214 and/or transaction clearing systems 214. The financial institutions and/or the transaction clearing houses may have a user account in the social network 100, a fund account associated with the user account, and may also be the financial institution operating or managing one or more of the fund accounts 102a, 104a, 106a, 108a, 110a, 112a, and/or 120a associated with one or more user accounts 102, 104, 106, 108, 110, and/or 112.

It is to be understood in the present disclosure that the user devices 202, 210, and 212, the seller machines 204, the financial institution systems (and transaction clearing systems) 214, and/or the social network servers 206 and databases 208 may be implementable on any computing device, computing system, and/or data storage unit, including cloud computing. Examples include a mobile device, a laptop computer, a desktop computer, a server, a processor, a POS system, a tablet, a phablet, a wearable computing device, an internet-enabled appliance, a television, a camera, a PDA, a smart phone, an NFC-enabled device, an RFID device, a card (such as a credit card, a smart card, a data storage card, or the like), and the like. It is also to be understood in the present disclosure that the user devices 202, 210, and 212, the seller machines 204, the financial institutions and transaction clearing systems 214, and the social network servers 206 depicted in FIG. 2 are merely example representations of user devices, seller machines, financial institutions and transaction clearing systems, and social network servers in the social network system 200, and that example embodiments of the social network system 200 may comprise many orders of magnitude more user devices, seller machines, financial institutions and transaction clearing systems, and/or social network servers without departing from the teachings of the present disclosure.

Each user device 202, 210, and 212 may be operable to interact with the social network 100 via the social network servers 206 in one or more of a plurality of ways. For example, each user device 202, 210, and 212 may be operable to create and/or cause the creation of one or more user accounts 102, 104, 106, 108, 110, and 112 in the social network 100; log in (such as with a username and a password) and/or cause the logging in to one or more of the user accounts 102, 104, 106, 108, 110, and 112 in the social network 100; associate and/or cause the association of a fund account 102a, 104a, 106a, 108a, 110a, and 112a to a user account 102, 104, 106, 108, 110, and 112 in the social network 100; socially link and/or cause the social linking to one or more other user accounts 102, 104, 106, 108, 110, and 112 in the social network 100; use, interact, and/or cause the use and/or interaction of actions and services available in the social network 100; and complete and/or cause the completion of a transaction for a purchasable item with a seller 204 by accessing funds in the fund account 102a, 104a, 106a, 108a, 110a, and 112a associated with the user account 102, 104, 106, 108, 110, and 112. For example, user device 202 may be operable to allow a user to log in to the first user account 102 and access the fund account 102a associated with the first user account 102, and such fund account 102a may be managed and/or operated by financial institution 214 and/or the social network server 206. It is to be understood in the present disclosure that the user device 202 may also be operable to allow the user and/or another user to log in to other user accounts.

The social network system 200 may further comprise one or more networks 201 (such as the internet, an intranet, a WiFi network, and/or a private network) for use by one or more of the social network servers 206, one or more of the databases 208, one or more of the user devices 202, 210, and 212, one or more seller devices 204, and one or more other systems (such as a financial institution 214 or transaction clearance organization 214), and for use in performing and/or accessing cloud computing for any of the aforementioned devices and/or systems.

In an example embodiment, a first user may register as a registered member of the social network 100 (for example, when the first user has not yet registered as a registered member of the social network 100). The first user may do so by using the first user device 202 to visit an internet website of the social network 100, visiting a representative (such as an office, retail shop, website, or equivalent) of the social network 100, installing a software application onto the first user device 202, and/or obtaining a new user device 202. Once a user account, such as first user account 102, has been created and registered in the social network 100 for the first user, the first user may log in to the first user account 102 using the first user device 202 (or any other computing device). The first user account 102 may also obtain an indicia associated with the first user account 102, and may also associate one or more fund accounts 102a with the first user account 102 and/or the indicia. The indicia for each user account may be provided by one or more of the social network servers (or processors) 206. In an example embodiment, the indicia may be storable in or on the user device 202 and/or retrievable upon demand (such as when a transaction is performed or being performed or anticipated to be performed for a purchasable item) from one or more of the social network servers 206 and/or databases 208.

The first user account 102 may also send social link requests to one or more other registered user accounts in the social network 100, such as second user account 104, third user account 106, fourth user account 108, fifth user account 110, and sixth user account 112. The first user account 102 may also accept social link requests sent from one or more other registered user accounts. It is to be understood in the present disclosure that the associating of one or more fund accounts to a user account, the sending of social link requests from a user account to another user account, and the accepting of social links requests from other user accounts may be performable in any order and at any time after registering a user account in the social network.

When the first user account 102 sends a social link request to another registered user account, the social link request may also include a request for authorization to access funds, either now or in the future, from the fund account of another user account. The request for authorization may be an authorization to always allow the first user account 102 to access funds from the fund account of the another user account (for example, always allow access to funds if the amount is less than or equal to a certain amount), to always require an approval from the another user account for each transaction, to always require an approval from the first user account 102, and the like. Furthermore, the authorization may include only allowing a certain amount of funds to be accessed per transaction, only allowing a certain total amount of funds to be accessed per time period (such as day, week, month, year, etc.), only allowing funds to be accessed based on a minimum balance that must be maintained in the fund account, and the like. The authorization may also include an express agreement and/or contract between the first user account 102 and the another user account that dictates one or more terms of the accessing of funds, such as an interest rate for funds that are accessed, a deadline to repay funds that are accessed, a penalty for not returning accessed funds within the deadline, a promise to allow the other user account to access funds, restrictions on accessing funds based on the type of transactions, currency of the transaction, currency of the return of funds accessed, etc.

In example embodiments, the indicia may be storable, either in a transitory or non-transitory manner, on a user device 202. The indicia may also be storable on a volatile or non-volatile storage card 202, such as a credit card, a smart card, a flash memory device, an RFID device, an NFC-device, another device operable to communicate with the user device 202, the network 201, the social network server 206, the seller 204, the financial institution 214, and/or the database 208, etc. The indicia may be provided to the user device 202 and/or the user of the user device 202 upon registering a user account of the social network 100 and/or accessing the user account of the social network 100. The indicia may be provided, either directly or indirectly, by one or more social network servers 206 and/or databases 208 to the user to download and save onto one or more user devices 202. The indicia may also be provided (or renewed), either directly or indirectly, by one or more social network servers 206 and/or databases 208 to the user device 202 periodically and/or intermittently, such as hourly, daily, monthly, quarterly, yearly, a particular time, a particular date, upon logging into the user account, upon conducing a transaction, etc. In this regard, the indicia may also comprise a time-limited or use-limited expiration. The indicia may also be provided, either directly or indirectly, by one or more social network servers 206 and/or databases 208 to the user device 202 on-demand, such as when the user wishes to perform and/or is in the process of performing a transaction for a purchasable item. It is to be understood in the present disclosure that the indicia may be storable and/or providable to the user device 202 as an encrypted code and through wired and/or wireless communication.

In example embodiments, the indicia of the user account may not be storable or providable to the user device 202 at all. For example, the indicia may in turn be associated with another one or more sets of unique characters or identification information of the user account, such as a credit card number or name of the user. In this regard, the indicia may be retrievable upon presenting the said another one or more sets of unique identification information of the user account. The indicia may also be retrievable directly from one or more of the social network servers 206 and/or databases 208 upon receiving a transaction request from the user device 202 and/or seller 204 (or a third party or another user account who the user device 202 is transacting with).

In example embodiments, the indicia of each user account may be operable to enable one or more of the social network servers 206 and/or databases 208 to exactly identify one or more of the user account associated with the indicia and/or the fund account associated with the user account and/or indicia. It is to be understood in the present disclosure that the indicia and use thereof may not be limited to those methods and forms described in the present disclosure, and other forms and methods of the indicia and providing the indicia are contemplated without departing from the teachings of the present disclosure.

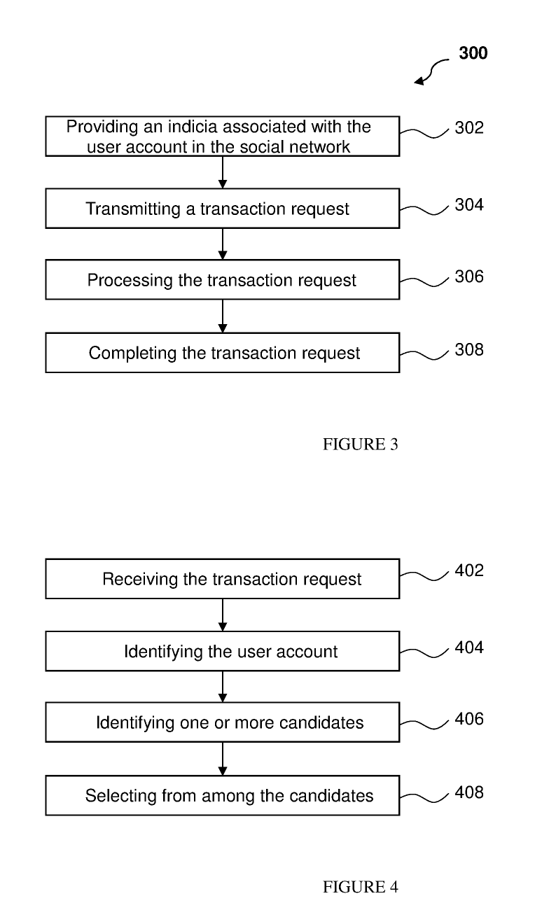

Example embodiments of a method of performing a transaction, such as a purchase transaction, will now be described with reference to FIGS. 3-5. A transaction for a purchasable item may be performable by a user account in one of a plurality of ways. In a situation wherein a user is physically present at a seller premise, such as a retail store, and the user wishes to make a transaction to purchase a purchasable item, the user may provide 302, either directly or indirectly, the indicia associated with the user account of the user to the seller and/or one or more of the social network servers 206 and/or databases 208. In such a situation, the user device 202 of the user may be operable to provide the indicia to a POS machine of the seller 204 via wireless or wired communication. As described above, if the user device 202 is a computing device, such as a mobile device 202, the indicia may be provided in one or more of a plurality of ways, such as via Bluetooth, email, SMS, WiFi, through a software application installed on the mobile device 202, such as a mobile application of the social network 100 and/or the seller, through a website of the social network 100 and/or the seller, and the like. If the user device 202 is an NFC-enabled device, an RFID, a card, and the like, the indicia may be provided in one or more of a plurality of ways, such as by bringing the user device 202 near to the seller device 204, scanning the user device 202 at a seller device 204, “tapping” the user device to the seller machine 204, and the like. As another example, a user may be visiting an online shop, such as an online retail store, and the user may provide 302, either directly or indirectly, an indicia associated with the user account of the user by, among other ways, entering the indicia and/or logging into a secure transaction clearance service.

As illustrated in FIG. 3, in performing a transaction with a third party (such as seller 204 or another user account), the user device 202 may provide 302, either directly or indirectly, the indicia of the user account to the third party and/or one or more of the social network servers 206. In addition or in the alternative, the third party and/or the user device 202 may provide 304, either directly or indirectly, a transaction request 304 to one or more of the social network servers 206, wherein the transaction request may include a total amount of the transaction (and may include taxes, etc.) and the indicia. In example embodiments, only the one or more social network servers 206 are operable to process the transaction request 306, including decrypting and identifying the indicia and identifying the total amount of the transaction. It is to be understood, however, that the third party may be operable to decrypt and identify the indicia and prepare and send the transaction request in example embodiments. Upon receiving the transaction request, the one or more social network servers 206 may be operable to complete 308 the transaction request.

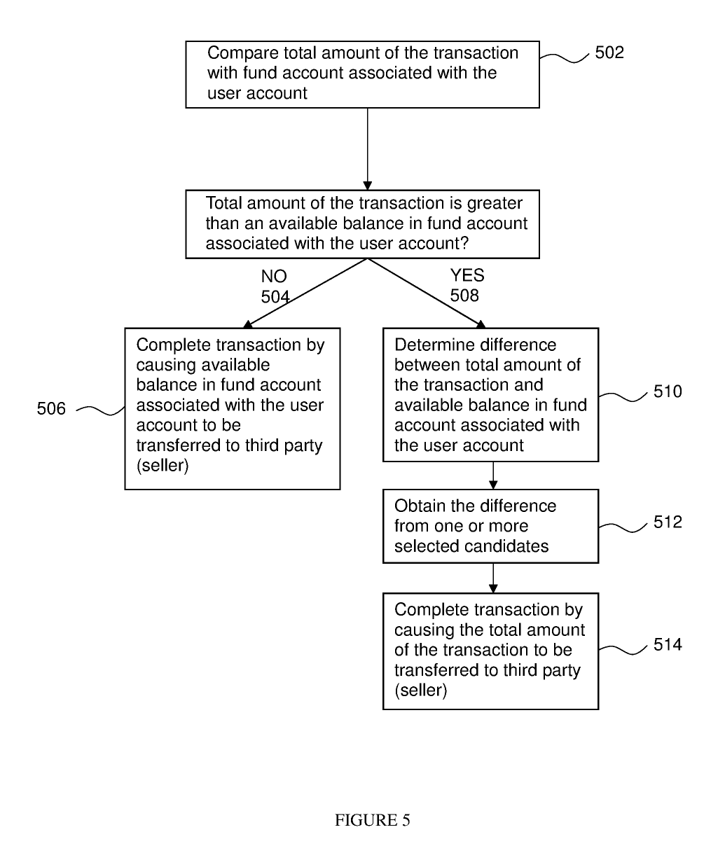

The processing 306 and completing 308 of the transaction request will now be further described with reference to FIGS. 4 and 5. After receiving the transaction request 402, the one or more social network servers 206 may perform an identifying of the first user account 404 based on the received indicia, and this step may also include the decrypting of an encrypted indicia.

Upon identifying the user account via the indicia, one or more of the social network servers 206 may be operable to access the fund account associated with the user account. Such accessing may first include determining, either directly or indirectly, one or more available balances in the fund account. In example embodiments, each user account may be operable to set, partition, assign, or the like, one or more portions or amounts of the overall available balance of the fund account associated with the user account. For example, a fund account associated with a user account may have an overall available balance of USD 100 in the fund account and a first amount of USD 50 in the fund account that is set to be used to perform transactions for purchasable items. As another example, a fund account associated with a user account may have an overall available balance of USD 100 in the fund account, a first amount of USD 80 in the fund account that is set to be used to perform transactions for purchasable items, and a second amount of USD 20 in the fund account set to be used for allowing other user accounts to access (such as borrowing) and/or returning any money accessed (such as borrowed) from the fund account associated with other user accounts. As another example, a fund account associated with a user account may have an overall available balance of USD 100 in the fund account, a first amount of 75% of the overall balance in the fund account set to be used to perform transactions for purchasable items, and a second amount of 10% of the overall balance in the fund account set to be used for allowing other user accounts to access (such as borrowing) and/or returning any money accessed (such as borrowed) from the fund account associated with other user accounts. It is to be understood in the present disclosure that other settings, partitions, assignments, and the like, of one or more portions or amounts of the overall available balance of the fund account associated with a user account are contemplated without departing from the teachings of the present disclosure.

Upon receiving the transaction request 402 and identifying the user account 404, one or more of the social network servers 206 may be operable to perform, either directly or indirectly, a comparison 502 of the total amount of the transaction provided in the transaction request with an available amount or balance in the fund account associated with the user account, such as the first amount described above.

In a situation wherein the total amount of the transaction is less than or equal to the available amount or balance (such as the first amount described above) 504, one or more of the social network servers 206 may be operable to, either directly or indirectly, complete or cause the completing of the transaction by using the available funds in the available amount or balance of the fund account associated with the user account.

In a situation wherein the total amount of the transaction is greater than the available amount or balance (such as the first amount described above) 508, one or more of the social network servers 206 may be operable to, either directly or indirectly, determine a difference (i.e. shortage) between the total amount of the transaction and the available amount or balance (such as the first amount described above) 510. Either before, during, and/or after the above step(s), one or more of the social network servers 206 may be operable to identify one or more candidates 406, which may be registered user accounts in the social network 100, for the user account to access funds if and/or when needed. Such identifying of candidates 406 may be performable on-demand, such as when a transaction request is received, periodically, intermittently, and/or continuously. In an example embodiment, the identifying of the candidates 406 may be performed upon receiving a transaction request 402, comparing 502, and determining that the user does not have sufficient funds to complete the transaction request 508.

The one or more candidates may be identified in one of a plurality of ways. For example, the identified candidates may be those user accounts in the social network 100 that are socially linked to the user account. As another example, the identified candidates may include those that are not socially linked to the user account, but is referred by and/or socially linked to another user account (such as a 2nd degree social link) that is already socially linked to the user account and has funds available for other user accounts to access. As another example, the identified candidates may include those user accounts that meet one or more criterion of the user account and/or the candidate. Such criterion may include zero or low interest rates; deadline to return funds; penalties (or lack of penalty for late return); those user accounts that have borrowed or accessed funds from the user account and/or candidate in the past; those user accounts and/or candidates that have a specific transaction history; a rating or ranking of the user account and/or candidates from among the social network 100, among those socially linked to the user account and/or the candidate, among those user accounts and/or candidates that have available funds, among those user accounts and/or candidates that have zero or low interest rates, among those user accounts and/or candidates who have borrowed or accessed funds in the past, among those user accounts and/or candidates that have a specific transaction history, etc.; and availability of funds for other user accounts and/or candidates to access. It is to be understood in the present disclosure that other ways and criterion for identifying candidates are contemplated without departing from the teachings of the present disclosure.

One or more candidates may then be selected 408 from among the identified one or more candidates. In an example, one candidate may be selected from among the identified one or more candidates. Such a situation may occur when the user account has specified that funds should only be accessed from one candidate, when the difference between the total amount of the transaction and the available funds balance in the fund account associated with the user account is relatively small, and/or in other situations. In another example, more than one candidate may be selected from among the identified candidates. Such a situation may occur when the user account has specified that funds should be accessed from more than one candidate, when the difference between the total amount of the transaction and the available funds balance in the fund account associated with the user account is sufficient to divide among more than one candidate, and/or in other situations. For example, if a total amount of the transaction is USD 10 and the available funds balance is USD 5, the one or more social network servers 206 may determine that 5 candidates should be selected to provide USD 1 each. As another example, the one or more social network servers 206 may determine that 25 candidates should be selected based on one or more user account criterion, and each candidate should provide USD 0.20 each. In such examples, the determination may be based on one of a plurality of reasons, such as a maximum or minimum limit of funds set by the user account and/or the candidates, a maximum or minimum limit of candidates set by the user account and/or the candidates, no other candidates are available that meet the criterion of the user account and/or the candidates, and the like. It is to be understood in the present disclosure that the candidates may provide equal amounts or may also provide different amounts to complete the transaction. It is also to be understood in the present disclosure that one or more socially linked user accounts may be “blocked” from accessing funds from one or more other user accounts, and this may be set by each user account.

The one or more social network servers 206 may then be operable to access or cause the access of the funds from the one or more candidates (as described above) 512 and provide (or transfer) the funds to the seller (either directly or indirectly) 514. In an example embodiment, the funds from the one or more candidates may be first provided to the fund account associated with the user account before providing the total amount of the transaction to the seller in one transfer (or payment). This may be desirable from the standpoint of the seller, which may identify or prefer to identify each incoming transfer of funds with the transaction (and/or the purchaser, i.e. the user of the user account). Alternatively or in addition, the funds from the one or more candidates may be provided to a centralized fund account of or a fund account managed by the social network 100, such as an electronic wallet or a cash top-up account. The available funds of the fund account associated with the user account may also be provided to the centralized fund account of or the fund account managed by the social network 100, such as an electronic wallet or a cash top-up account. Once the total amount of the transaction is provided, one or more of the social network servers 206 may transfer or cause the transfer of the total amount of the transaction to the seller in one or more transfers (or payment).

In an example embodiment, each user account in the social network 100 may be limited to access a maximum amount of funds per transaction and maximum total amount of funds outstanding. For example, a first user account 102 may be limited to access a maximum total amount of funds outstanding of USD 20. When the first user account 102 has reached the maximum total amount of funds outstanding of USD 20, the first user account 102 will no longer be able to access any funds from any other user accounts until the total owing or outstanding amount is reduced to below the maximum total amount of funds outstanding. The first user account may do this by adding, refilling, and/or topping-up the fund account associated with the user account and returning one or more of the previously accessed funds (such as borrowed funds), either in part or in whole, to one or more of the fund accounts associated with one or more other user accounts.

As described above, the fund account associated with a user account may be any type of fund account. In an example embodiment, the fund account may be an electronic wallet or cash top-up account associated with the user account. The user may add, refill, and/or top-up the fund account by any one or more ways, including transfers from a bank account, transfers from an ATM machine, transfers at a POS system at a retail store (such as 7 Eleven, Family Mart, etc.), and the like. For user accounts, such as first user account 102, which have previously accessed (such as borrow) funds from the fund account of another user, such as second user account 104, the user account may be set to return the previously accessed funds (such as borrowed funds) in one of a plurality of ways. For example, the user account may be set to automatically or manually (such as by receiving alerts from the social network 100) return previously accessed funds based on the transaction date (example, whichever user account was accessed first will be paid back first), based on the interest rate charged (example, whichever charges more interest), based on deadline to pay (example, whichever deadline is coming up first), based on penalty (example, whichever has a more severe penalty), and the like. The user account may also be set to automatically or manually (such as by receiving alerts from the social network 100) to return previously accessed funds in one or more of the above ways and whenever the user adds, refills, and/or tops-up the fund account, as described above. For example, when the user adds money to the electronic wallet associated with the user account, the new balance (such as the new balance of the second amount, as described above) may trigger an automatic and/or manual payment, either in full and/or in part, of one or more previously borrowed amounts to one or more fund accounts associated with one or more other user accounts.

While various embodiments in accordance with the disclosed principles have been described above, it should be understood that they have been presented by way of example only, and are not limiting. Thus, the breadth and scope of the example embodiments described in the present disclosure should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

For example, as referred to in the present disclosure, a device, processor, or system may be a virtual machine, computer, node, instance, host, or device in a networked computing environment. A networked computing environment may be a collection of devices connected by communication channels that facilitate communications between devices and allow devices to share resources. Also as referred to in the present disclosure, a processor may be a device deployed to execute a program operating as a socket listener and may include software instances.

Resources may encompass any type of resource for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and software infrastructures configured to form a virtual organization comprised of multiple resources that may be in geographically disperse locations.

Furthermore, the coverage of the present application and any patents issuing from the present application may extend to one or more communications protocols, including TCP/IP.

Various terms used in the present disclosure have special meanings within the present technical field. Whether a particular term should be construed as such a “term of art” depends on the context in which that term is used. “Connected to,” “in communication with,” “associated with,” or other similar terms should generally be construed broadly to include situations both where communications and connections are direct between referenced elements or through one or more intermediaries between the referenced elements. These and other terms are to be construed in light of the context in which they are used in the present disclosure and as one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under various patent regulations and practice, or otherwise to provide organizational cues. These headings shall not limit or characterize the embodiments set out in any claims that may issue from this disclosure. Specifically, a description of a technology in the “Background” is not to be construed as an admission that technology is prior art to any embodiments in this disclosure. Furthermore, any reference in this disclosure to “invention” in the singular should not be used to argue that there is only a single point of novelty in this disclosure. Multiple inventions may be set forth according to the limitations of the claims issuing from this disclosure, and such claims accordingly define the invention(s), and their equivalents, that are protected thereby. In all instances, the scope of such claims shall be considered on their own merits in light of this disclosure, but should not be constrained by the headings herein.

1-71. (canceled)

72. A system for transforming information provided by computing devices into computer-implementable instructions, the system comprising:
a network; and
a processor in communication with the network, the processor operable to:
establish a first communication channel with a first user device via the network;
establish a second communication channel with a second user device via the network;
create a first user account based on information received from the first user device via the first communication channel;
create a second user account based on information received from the second user device via the second communication channel;
associate a first computer-enabled account to the first user account and a second computer-enabled account to the second user account;
create a computer-processable indicia associated with the first user account, the computer-processable indicia for use in transforming information receivable by the processor into instructions implementable by the processor;
create a network link between the first user account and the second user account; and
perform a transformation of information received from the first user device by:
receiving, from the first user device, a computer-processable request, the computer-processable request including the computer-processable indicia associated with the first user account; and
processing the computer-processable request, the processing of the computer-processable request based on a current status of the first user account and the network link between the first user account and the second user account.
